(19) United States
(12) Patent Application Publication
(10) Pub. No.: US 2018/0344050 A1
(43) Pub. Date: Dec. 6, 2018

(54) BABY-CHANGING MAT, BABY-CHANGING UNIT HAVING SUCH A MAT, AND USE OF THE SAME

(71) Applicant: Frank Wiegand, Oberursel (DE)

(72) Inventor: Frank Wiegand, Oberursel (DE)

(21) Appl. No.: 15/777,460

(22) PCT Filed: Sep. 7, 2016
(86) PCT No.: PCT/EP2016/071112

§ 371 Date: May 18, 2018

(30) Foreign Application Priority Data
Nov. 20, 2015 (EP) 15195599.4

(51) Int. Cl. A47D 5/00; B60N 3/00

(52) U.S. Cl. CPC A47D 5/00; B60N 3/008

(57) ABSTRACT

In the case of a baby-changing mat (10) having an upper side (11), a lower side (12), a first and a second lateral delimitation (13, 14), said lateral delimitations (13, 14) being mutually opposite, and a front end (15) and a rear end (16), said ends (15, 16) being aligned so as to be transverse to the first and the second lateral delimitation (13, 14), the invention provides that the front end in comparison to the rear end has a taper. Moreover, the invention relates to a baby-changing device (1) having such a baby-changing mat (10), and a straightening device (50) by way of which the baby-changing mat (10) over a geodetically oblique support surface (U) is alignable so as to be geodetically straight. The invention furthermore relates to the use of the baby-changing mat (10) and of the baby-changing device (1).

### CROSS-REFERENCE TO RELATED APPLICATIONS

The present application claims priority to PCT Application No. PCT/EP2016/071112, titled “Baby-changing mat, baby-changing unit having such a mat, and use of the same” and filed on Sep. 7, 2016, which claims priority to EP 15195599.4, which was filed on Nov. 11, 2015, the contents of each of which is incorporated by reference herein in their entirety.

### FIELD OF THE INVENTION

The invention relates to a baby-changing mat, to a baby-changing device having such a mat, and the use of the same.

### BACKGROUND

Various support pads for changing the diapers of babies and infants are known from the prior art. Cloth sheets, thin pads and also somewhat thicker mats are used. However, cloth sheets and pads are largely used outside of homes, because the former are easier to transport than mats.

In the case of all these variants, changing diapers on oblique and uneven support surfaces, such as is present in particular on vehicle seats, is problematic. The child, when being handled, herein often rolls over the shoulder in the direction of the seat back. Handling is accordingly difficult, unsuccessful, and leads to stress for the parents and the child.

Many variants are difficult to clean and on cold support surfaces offer inadequate thermal insulation.

It is therefore an object of the invention to provide a device and the use thereof by way of which the diapers of a child can be changed in a comfortable and simple manner a child in as many everyday situations as possible. Additionally, the device should be simple to transport, compact to carry along, simple in terms of handling, thermally insulating, and easy to clean.

### SUMMARY OF THE INVENTION

Main features of the invention are set forth in the characterizing part of claim 1 and of claims 8 and 11. Design embodiments are the subject matter of claims 2 to 7, 9 to 10, and 12 to 17.

The invention relates to a baby-changing mat having an upper side, a lower side, a first lateral delimitation and a second lateral delimitation, said lateral delimitations being mutually opposite, and having a front end and a rear end, said ends being aligned so as to be transverse to the first and the second lateral delimitation, wherein the front end in comparison to the rear end has a taper.

The advantage of the taper according to the invention lies in that the baby-changing mat is readily placeable on a vehicle seat without the lying surface being excessively reduced. For example, a side bolster of a seat back can lie in the taper. The first lateral delimitation that is shortened by the taper can in this instance bear on the backrest of the vehicle seat, that is to say that there is no crevice herein into which the baby could roll. In another application, in particular when the person performing the change does not have frontal lateral access to the vehicle seat, it is also possible for the backrest to be positioned in the taper and for the baby-changing mat to be aligned diagonally on the vehicle seat. Despite the taper, a large bearing face herein also remains between the lower side and the vehicle seat such that the baby-changing mat is not at risk of tilting from the seat. Of course, the baby-changing mat can also be used at other locations of application than on vehicle seats. The upper side preferably configures a planar lying surface. A lying depression in the case of a soft embodiment is created solely by placing the baby thereon. However, a lying depression can optionally also be configured in the unstressed baby-changing mat. On account thereof, any rolling of the child is more intensely counteracted. The lower side should configure a planar bearing face. On account thereof, the baby-changing mat in the everyday use can be spread out and utilized without any problems on all planar faces. The first and the second lateral delimitation, and the front and the rear end, frame the upper side and the lower side, and delimit the extent of the latter two, respectively.

An optional design embodiment provides that the first lateral delimitation and the second lateral delimitation are aligned so as to be at least substantially mutually parallel. This results in a portion with a consistent width of the lying surface.

In a particular embodiment of the baby-changing mat, the taper is at least in part configured by a first blunt corner between the front end and the first lateral delimitation. A large lying surface which narrows only in the region of the first blunt corner can thus be provided.

With a view to as high a flexibility as possible in terms of the location of application, in particular also on vehicle seats or seats of passenger motor vehicles, respectively, a design embodiment in which the first blunt corner at the side of the front end extends across 10% to 50%, preferably across 20% to 45%, furthermore preferably across 25% to 42%, and particularly preferably across 30% to 40% of the spacing between the first and the second lateral delimitation is expedient.

An embodiment as per which the first blunt corner on the side of the first lateral delimitation extends across 15% to 40%, preferably across 17% to 38%, furthermore preferably across 20% to 35%, and particularly preferably across 25% to 30% of the spacing between the front end and the rear end also contributes to this end.

In principle, the first blunt corner could have a concave or convex curvature. However, in the case of one special design of the baby-changing mat, the first blunt corner is configured by an oblique first corner edge of the baby-changing mat. Such an in particular straight corner edge forms a stable bearing face without a depression toward the adjacent part, such as a seat back, being created. Moreover, the remaining lying surface is large. Particularly preferably, the first corner edge in relation to the first lateral delimitation and to the front end, or a front edge, respectively, is aligned at an angle between 35 degrees and 55 degrees, preferably between 40 degrees and 50 degrees, and particularly preferably of 45 degrees. The interior angle should thus be between 145 degrees and 125 degrees.

An even higher flexibility in terms of the location of application is achieved by way of an optional embodiment of the baby-changing mat in which the taper is at least in part, in particularly additionally to the first blunt corner, configured by a second blunt corner between the front end and the second lateral delimitation. The baby-changing mat can thus be used without any restriction on both sides of a vehicle. The upper side and the lower side herein can be composed of dissimilar materials. For example, the lower side can have a higher degree of anti-slip properties, and/or a higher robustness, than the upper side. In particular, the upper side can have a better cleaning ability and/or sensory appeal than the lower side.

Since vehicle seats are mostly constructed so as to be substantially symmetrical in the vehicle, a design in which the second blunt corner is similar to the first blunt corner is expedient. In particular, the second blunt corner at the side of the front end should extend across 10% to 50%, preferably across 20% to 45%, furthermore preferably across 25% to 42%, and particularly preferably across 30% and 40% of the spacing between the lateral delimitations, or lateral edges, respectively. Furthermore, the second blunt corner at the side of the first lateral delimitation should extend across 15% to 40%, preferably across 17% to 38%, furthermore preferably across 20% to 35%, and particularly preferably across 25% to 30% of the spacing between the front end and the rear end. The second blunt corner can optionally be configured by an oblique second corner edge of the baby-changing mat. The second blunt corner is particularly preferably configured so as to be at least substantially a mirror image of the first blunt corner.

In one special variant the baby-changing mat has a flat collar which frames the upper side and the lower side. Such a frame offers protection for potential thin, sensitive skin of the first air chamber. The upper side and the lower side herein can be interconnected in the collar, for example by adhesive bonding or welding. The collar should have a width of maximum 5.0 cm, preferably of maximum 4.0 cm.

There is furthermore the option of hanger holes being configured in the baby-changing mat. By way of the latter, the baby-changing mat can be fastened in a suspended manner for use or storage. The optional collar is particularly suitable as an attachment location. This means that the hanger holes are configured in the collar of the baby-changing mat.

An embodiment according to which the baby-changing mat is configured to be flat has been particularly successful in practice, the spacing between the first and the second lateral delimitation, or a lateral edge, respectively, preferably being at least 5 times, preferably at least 7 times, and particularly preferably at least 10 times the spacing between the upper side and the lower side.

Special absolute dimensions of the baby-changing mat prove to be particularly advantageous in terms of the application with a baby or an infant and on a car seat. In particular, the spacing between the front end and the rear end should be between 40 cm and 90 cm, preferably between 50 cm and 85 cm, furthermore preferably between 55 cm and 80 cm, and particularly preferably between 60 cm and 75 cm.

Furthermore, a dimensional specification in which the spacing between the first and the second lateral delimitation or lateral edge, respectively, is between 35 cm and 70 cm, preferably between 40 cm and 65 cm, furthermore preferably between 45 cm and 65 cm, and particularly preferably between 50 cm and 60 cm is expedient.

Moreover, absolute dimensions in which the spacing between the upper side and the lower side is between 3.0 cm and 9.0 cm, preferably between 3.5 cm and 7 cm, particularly preferably between 4 cm and 6 cm are advantageous. On account thereof, a sufficient rigidity can be achieved with a small packing or air volume, respectively.

According to one optional design embodiment of the baby-changing mat, at least one first air chamber is disposed in said baby-changing mat, wherein the baby-changing mat is rigidified upon charging the first air chamber with air. In the converse case, the baby-changing mat is less rigid. In particular, the baby-changing mat is limp in the case of the first air chamber being vented. The baby-changing mat in this instance should not have any inherent rigidity and is preferably collapsible. The baby-changing mat, being vented and compact, can thus be comfortably carried along. For aerating and venting, the baby-changing mat should have a first air valve. This first air valve can open into the first air chamber. The first air valve is preferably disposed on the circumference of the baby-changing mat, in particular between the upper side and the lower side. Here, said air valve disturbs neither the baby lying thereon, nor does the former configure any unevenness on the lower side. Moreover, the valve here can be most readily charged by mouth. In order for any oblique support surface to be equalized, an object can be placed under the rigid baby-changing mat in order for the gradient to be compensated for. By virtue of the rigidity of the baby-changing mat, a lining over the entire surface is not required. A further advantage of the first air chamber is the positive thermal insulation of the child in relation to the support surface. Infections on account of hypothermia are avoided.

The first air chamber can be a pure cavity which is chargeable with air. This means that no unfolding means are present. This is particularly cost-effective. However, in one variant of the baby-changing mat, the latter has elastic unfolding means which exert an unfolding force on the air chamber. The effort in blowing up is thus at least partially minimized as the aerating is at least in part performed without an active input. The baby-changing mat to a certain extent should be a self-inflating air bed. An elastic foam material is particularly preferably disposed in the air chamber. The volume of the foam material can be kept small by way of optional longitudinal ducts and/or transverse ducts and/or vertical cavities. On account thereof, the baby-changing mat 10 is readily ventable and collapsible. Moreover, the baby-changing mat has a low weight for transport.

The invention moreover relates to a baby-changing device having a baby-changing mat which has an upper side, a lower side, a first lateral delimitation and a second lateral delimitation, said lateral delimitations being mutually opposite, and a front end and a rear end, said ends being aligned so as to be transverse to the first and the second lateral delimitation, and having a straightening device by way of which the baby-changing mat over a geodetically oblique support surface is alignable so as to be geodetically straight. It is thus achieved that the baby-changing mat configures a planar bearing for the baby, the latter consequently not rolling when handled. In principle, the baby-changing mat can be, for example, a flat element in the form of a rectangle with or without rounded corners, an egg, an oval, or a combination of a rectangle and a semicircle.

The invention relates in particular to a baby-changing device having a baby-changing mat having a taper at the front end, such as is described hereabove and hereunder, and a straightening device by way of which the baby-changing mat over a geodetically oblique support surface is alignable so as to be geodetically straight.

It is thus likewise achieved that the baby-changing mat configures a planar bearing for the baby, the latter consequently not rolling when handled. Moreover, the baby-changing mat by virtue of the taper is usable in a particularly flexible and positive manner on car seats.

In one variant of embodiment of the baby-changing device, the straightening device has an air cushion which is disposed on or below the lower side of the baby-changing mat. An air cushion has the advantage that the latter in terms of the thickness can be readily adapted to the support surface by aerating or venting. Moreover, said air cushion compensates for unevenness in the support surface by redistributing the air. To this end, the air cushion should have a second air chamber. Optionally, the thickness of the air cushion perpendicularly to the lower side of the baby-changing mat is capable of being set by charging the second air chamber with air in a variable manner. An embodiment according to which the maximum thickness of the air cushion is between 4 cm and 20 cm, preferably between 8 cm and 18 cm, furthermore preferably between 11 cm and 17 cm, and particularly preferably between 12 cm and 16 cm has proven particularly successful in practice. A compatibility with most vehicle seats is achieved by way of such a dimensional specification. The air cushion should have a second air valve for aerating and venting. This second air valve can open into the second air chamber. The second air valve preferably opens into the second air chamber on the circumference about the length and the width, in particular between a cushion upper side and a cushion lower side. The second air valve here does not configure any unevenness on the cushion upper side and the cushion lower side. Moreover, the second air valve can be readily reached by mouth for inflating. A cushion collar which frames the cushion upper side and the cushion lower side is optionally configured on the circumference of the air cushion between the cushion upper side and the cushion lower side. The cushion upper side and the cushion lower side can be interconnected in the cushion collar. Moreover, the baby-changing device is usable in a particularly flexible manner when the air cushion is not fastened to the baby-changing mat. Rather, said air cushion should be shimmied in a loose manner.

A dimensional specification in which the maximum thickness of the air cushion, in particular between the cushion upper side and a cushion lower side is smaller than the length of the air cushion is optimal for a stable support of the baby-changing mat. The optional dimensional specification according to which the maximum thickness of the air cushion is smaller than the width of the air cushion also contributes toward this end. An air cushion in which the width of the air cushion is smaller than the length of the air cushion can be disposed in a variable manner on an uneven support surface such as a vehicle seat. An absolute size of the air cushion in which the maximum length of the air cushion is between 20 cm and 55 cm, preferably between 25 cm and 50 cm, furthermore preferably between 30 cm and 46 cm, and particularly preferably between 35 cm and 43 cm has been successful in practice. Moreover, a design according to which the maximum width of the air cushion is between 8 cm and 25 cm, preferably between 10 cm and 24 cm, furthermore preferably between 12 cm and 23 cm, and particularly preferably between 13 cm and 22 cm has moreover proven successful.

Dimensional specifications are advantageous also in relation to the size of the baby-changing mat. The maximum thickness of the air cushion should thus be larger than the spacing between the upper side and the lower side of the baby-changing mat. The baby-changing mat thus remains compact, and a comparatively large unevenness, or gradient, respectively, in the support surface can be equalized by way of the air cushion. Moreover, the length and the width of the air cushion should be smaller than the spacing between the first and the second lateral delimitation of the baby-changing mat. In particular, this allows the air cushion to be readily inserted into a vehicle seat which has side bolsters on the seat face and/or on the backrest.

The optional disposal of the air cushion below the lower side of the baby-changing mat can be performed in various manners. In one variant, the air cushion bears loosely on the baby-changing mat, that means without any coupling means. On account thereof, the air cushion is freely positionable in relation to the baby-changing mat. In a second variant, the baby-changing mat and the air cushion are connected by way of releasable coupling means. For example, buttons, hook-and-pile fasteners, or zip fasteners are suitable. Slipping of the air cushion below the baby-changing mat is thus avoided. In a third variant, the air cushion is fixedly connected to the baby-changing mat. The air cushion and the baby-changing mat herein are optionally produced in an integral manner. This variant is cost-effective. For example, the air cushion in this instance can then be folded under the baby-changing mat.

Since dissimilar, or independent, respectively, air pressures are required in order to achieve the objectives of a rigid baby-changing mat and of a set thickness of the air cushion, a design embodiment in which the air cushion and the baby-changing mat have in each case separate air chambers and separate air valves is expedient. This means that the first air chambers and the second air chamber do not have any gas-permeable connection. This moreover means that the first air valve and the second air valve are different. The first and/or the second air chamber can in each case optionally be composed of a plurality of part-chambers which are either fluidically connected or in each case have a dedicated valve.

The air valves are preferably automatically closing, or are closable by mouth, in particular by exerting pressure. No air thus escapes after the air pressure has been reached and prior to the valve having been closed. A one-way reversing valve proves particularly advantageous. Charging with air herein is possible only in the first orientation. On account thereof, no air escapes when the mouth pauses. In the reverse orientation, air should only be allowed to escape. On account thereof, the air can be readily squeezed out, and the air chamber is not refilled when handling. In as far as the reversing valve does not sit in a receptacle provided therefor, air can stream freely through the receptacle. Such a reversing valve can be complemented by a closure means. The air pressure in the air chamber in this instance is maintained over a comparatively long period of time. The one-way reversing valve is particularly suitable when combined with unfolding means.

In one particularly comfortable and readily transportable embodiment, the air cushion configures a packing chamber for the baby-changing mat. The air cushion can thus receive the baby-changing mat for transportation. To this end, a closable packing opening can open into the second air chamber. The packing opening is optionally embodied so as to be capable of being rolled up. The packing opening can be closed by being rolled up in a manner corresponding to that of a water-tight packing bag (wet bag) and is adequately air-tight at least for one baby-changing procedure. A closure strap for rolling up and packing the baby-changing device should be disposed along the packing opening. Said closure strap can be rapidly opened and closed with the aid of an optional buckle. The packing opening can thus also be rapidly opened and closed.

In another variant, the cushion front side or the cushion rear side is configured having double walls, having an internal wall and an external wall, a packing opening being configured in the external wall, and a packing space being configured in the intermediate space between the internal wall and the external wall.

According to one optional design embodiment of the baby-changing device, the straightening device has a holding strap which is fixable to a headrest of a vehicle. The baby-changing mat can thus be held so as to be suspended over the oblique seat face. To this end, the holding strap should be fixable, or fixed, respectively, to the baby-changing mat. The holding strap is preferably fixable, or fixed, respectively, to the optional hanger holes in the baby-changing mat. In order for the holding strap to be readily attached to and removed from the baby-changing mat, the holding strap should have a latching means, in particular hooks.

The baby-changing device can be complemented by a printed version of the instruction manual on the air cushion and/or the baby-changing mat. The operating steps are preferably illustrated in sequence by images.

The invention furthermore relates to a use of a baby-changing mat such as is described above and hereunder, or of a baby-changing device as is described above or hereunder, for changing the diapers of a baby or infant. A comfortable changing of diapers without stress is possible for the person changing the diaper and for the child to be changed in a multiplicity of everyday surroundings on account of the use of said baby-changing mat. The risk of contamination is minimized.

In an optional application case of the baby-changing device, the use is performed on a vehicle seat of a vehicle. The first blunt corner permits a flexible and positive bearing of the baby-changing mat on the vehicle seat, and the further advantages according to the description above can also be implemented, depending on the optional design potentials of the baby-changing mat or of the baby-changing device.

A special use variant provides that a side bolster of a backrest of the vehicle seat lies in the taper, in particular in the first blunt corner, or corner clearance, respectively, and the first and the second lateral delimitation are aligned longitudinally in relation to a front seat edge of a seat face of the vehicle seat, or to the vehicle axis. The child on the baby-changing mat is thus readily accessible in the case of readily accessible vehicle seats.

In another use variant it is provided that a central part of a backrest of the vehicle seat lies in the taper, in particular in the first blunt corner, or corner clearance, respectively, and the first and the second lateral delimitation are aligned diagonally in relation to a front seat edge of a seat face of the vehicle seat, or to the vehicle axis, respectively. This is advantageous in particular when only an oblique access to the vehicle seat is possible on account of the position and the opening angle of the vehicle door. On account of the diagonal alignment of the baby-changing mat, the child lying thereon can be aligned so as to be perpendicular to the person changing the diaper.

An optional complimentary use lies in that at least one first air chamber is disposed in the baby-changing mat, wherein the baby-changing mat is rigidified by charging the first air chamber with air. The baby-changing mat is thus transferred from a readily storable state to the operating state. Complete aerating can be dispensed with on a planar support surface under certain circumstances. However, in the case of an inherent rigidity of the baby-changing mat the child does lie in a substantially more comfortable state on a non-planar support surface.

The use can be complemented in that the baby-changing device has a straightening device by way of which the baby-changing mat over a geodetically oblique support surface is aligned so as to be geodetically straight. It is thus effectively prevented that the child in the case of an oblique support surface is inadvertently set in motion on the baby-changing mat. Consequently, said child does not have to be held in place. Therefore, the hands are more available for the actual baby-changing task.

In one special use it is provided that the straightening device has an air cushion which is or is to be disposed on or below the lower side of the baby-changing mat, and/or has a holding strap which is fixable to a headrest of a vehicle, wherein a geodetic alignment over the geodetically oblique supporting surface is performed by setting the quantity of air in the air cushion below the baby-changing mat and/or fixing the holding strap above the baby-changing mat and setting the length of the holding strap. A gradient on the vehicle is thus equalized in a simple manner, and the baby-changing mat configures a horizontal bearing stop. To this end, the air cushion should lie in the seat depression between lateral elevations of the seat face, or side bolsters, respectively. Said air cushion here can at least partly fill the depression and the baby-changing mat can be supported on the air cushion. Additionally, the baby-changing mat can bear partially on the lateral elevations, or the seat bolsters, respectively. Said baby-changing mat is additionally mounted in a stable manner on account thereof.

### BRIEF DESCRIPTION OF THE DRAWINGS

Further features, details, and advantages of the invention are derived from the wording of the claims and from the following description of exemplary embodiments by means of the drawings in which:

FIG. 1 shows a perspective view of a baby-changing mat;

FIG. 2 shows a plan view of the baby-changing mat as per FIG. 1;

FIG. 3 shows a side view of the baby-changing mat as per FIG. 1;

FIG. 4 shows a perspective view of a straightening device that is configured as an air cushion;

FIG. 5 shows a perspective view of a straightening device that is configured as a holding strap;

FIG. 6 shows a plan view of a baby-changing device having a baby-changing mat as per FIG. 1 and a straightening device, in a first use on a vehicle seat;

FIG. 7 shows a front view of the arrangement shown in FIG. 6;

FIG. 8 shows a side view of the arrangement shown in FIG. 6;

FIG. 9 shows a plan view of a baby-changing device having a baby-changing mat as per FIG. 1 and a straightening device, in a second use on a vehicle seat;

FIG. 10 shows a front view of the arrangement shown in FIG. 9; and

FIG. 11 shows a side view of the arrangement shown in FIG. 9.

### DETAILED DESCRIPTION OF THE INVENTION

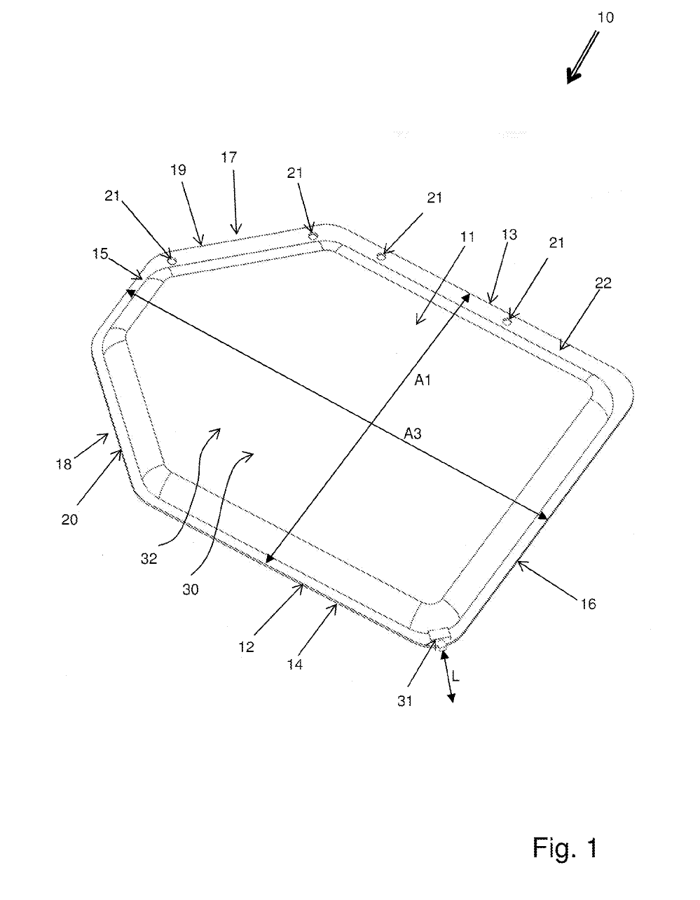

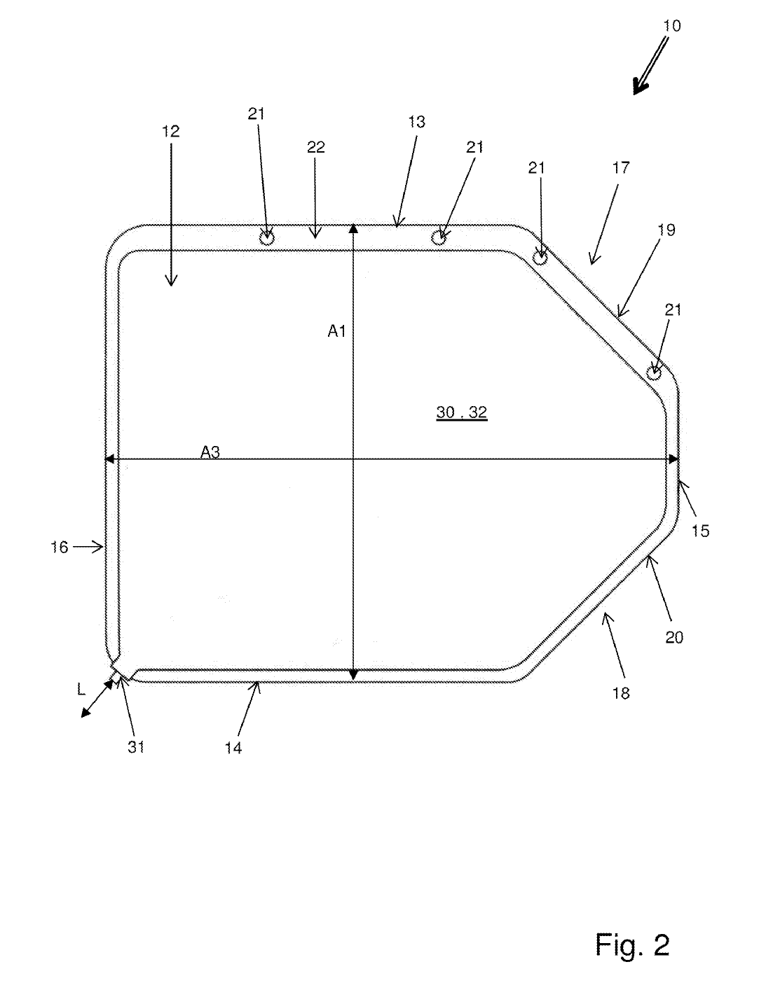

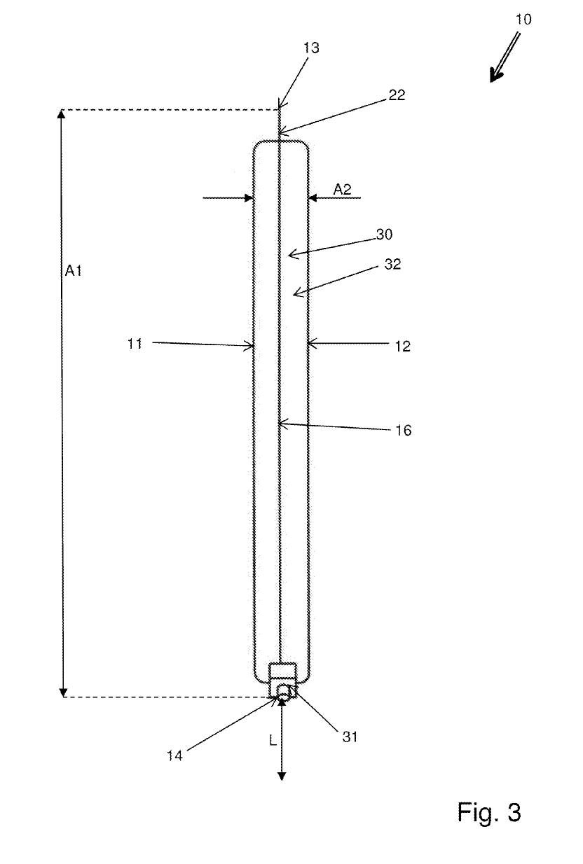

A perspective view of a baby-changing mat 1 can be seen in FIG. 1. Said baby-changing mat 1 is additionally shown in a plan view in FIG. 2 and in a side view in FIG. 3. It can be seen in FIGS. 1, 2, and 3 that the baby-changing mat 10 has an upper side 11 (to be seen only in FIGS. 1 and 3), a lower side 12, a first and a second lateral delimitation 13, 14, said delimitations being mutually opposite and being aligned so as to be substantially mutually parallel, and a front end 15, or a front edge (to be seen only in FIGS. 1 and 2), respectively, and a rear end 16, or a rear edge, respectively, said ends being aligned so as to be transverse to the first and the second lateral delimitation 13, 14. The upper side 11 configures a planar lying surface, and the lower side 12 configures a planar bearing face.

A first air chamber 30 is disposed in the baby-changing mat 10, on account of which the baby-changing mat 10 in the case of the first air chamber 30 being charged with air L is rigid. When the first air chamber 30 is vented, the baby-changing mat 10 is limp. Said baby-changing mat 10 in this instance has no inherent rigidity and can be collapsed. A first air valve 31 for aerating and venting the first air chamber 30 opens into the first air chamber 30. The first air valve 31 is disposed on the circumference of the baby-changing mat 10 between the upper side 11 and the lower side 12. The baby-changing mat 10 is presently embodied as a self-inflatable air bed, in that elastic unfolding means 32 in the form of an elastic foam material are disposed in the first air chamber 30, said unfolding means 32 exerting an unfolding force on the air chamber 30. The volume of the foam material can be kept small on account of longitudinal and transverse ducts or else vertical cavities. On account thereof, the baby-changing mat 10 is easy to vent, readily collapsible, and light.

The baby-changing mat 10 furthermore has a flat collar 22 which frames the upper side 11 and the lower side 12. The upper side 11 and the lower side 12 are interconnected, in particular welded or adhesively bonded, in this collar 22. As can be seen in FIGS. 1 and 2, hanger holes 21 are configured in the collar 22.

The baby-changing mat 10 is configured so as to be overall flat. The spacing A1 between the first and the second lateral delimitation 13, 14 herein is at least 5 times, preferably at least 7 times, and particularly preferably at least 10 times the spacing A2 (cf. FIG. 3) between the upper side 11 and the lower side 12. In absolute values, the spacing A3 between the front end 15 and the rear end 16 is between 40 cm and 90 cm, preferably between 50 cm and 85 cm, furthermore preferably between 55 cm and 80 cm, and particularly preferably between 60 cm and 75 cm. Moreover, the spacing A1 between the first and the second lateral delimitation 13, 14 is between 35 cm and 70 cm, preferably between 40 cm and 65 cm, furthermore preferably between 45 cm and 62 cm, and particularly preferably between 50 cm and 60 cm.

According to FIGS. 1 and 2, a first blunt corner 17, or a first corner clearance, respectively, is configured by an oblique corner edge 19 between the front end 15, in particular a front edge, and the first lateral delimitation 13. On account thereof, the front end 15 is tapered as compared to the rear end 16. The first blunt corner 17 at the side of the front end 15 extends across a length between 10% and 50%, preferably between 20% and 45%, furthermore preferably between 25% and 42%, and particularly preferably between 30% and 40% of the spacing A1 between the first and the second lateral delimitation 13, 14. Moreover, the length of the first blunt corner 17 at the side of the first lateral delimitation 13 is between 15% and 40%, preferably between 17% and 38%, furthermore preferably between 20% and 35%, and particularly preferably between 25% and 30% of the spacing A3 between the front end 15 and the rear end 16. The first corner edge 19 presently forms an angle of 45 degrees in relation to the first lateral delimitation 13 and in relation to the front end 15, or the front edge, respectively. The internal angle is thus 135 degrees.

Moreover, a second blunt corner 18 which is similar to the first blunt corner 17 is configured by means of a second corner edge 20 between the front end 15 and the second lateral delimitation 14. A taper at the side of the front end 15 as compared to the rear end 16 is thus also present on account thereof. The second blunt corner 18 is presently configured so as to be a mirror image of the first blunt corner 17. This relates in particular to the collar 22. By contrast, the first air chamber 30 is slightly displaced in an asymmetrical manner such that the collar 22 at the first lateral delimitation 13 is wider than at the second lateral delimitation 14. The hanger holes 21 are to be found in the wider collar portion on the side of the first lateral delimitation 13.

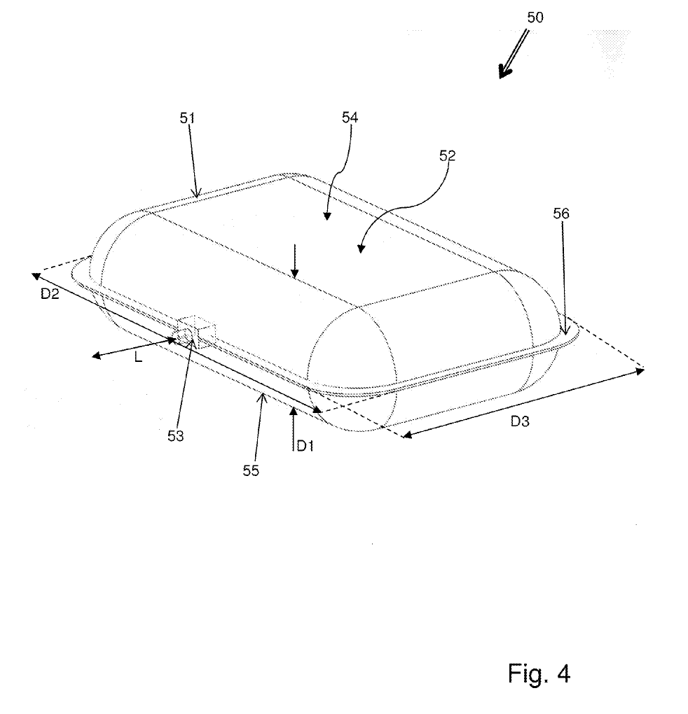

FIG. 4 shows a perspective view of a straightening device 50 that is configured as an air cushion 51, the baby-changing mat 10 as per FIGS. 1 to 3 over a geodetically oblique support surface being alignable so as to be geodetically straight by way of said straightening device 50.

The air cushion 51 has a cushion upper side 54 and a cushion lower side 55. A cushion collar 56 which frames the cushion upper side 54 and the cushion lower side 55 is configured on the circumference of the air cushion 51 between the cushion upper side 54 and the cushion lower side 55. The cushion upper side 54 and the cushion lower side 55 are interconnected, in particular welded or adhesively bonded, in the cushion collar 56.

The air cushion 51 likewise has an air chamber 52 (referred to hereunder as the second air chamber 52) into which a second air valve 53 opens. The second air valve 53 is disposed in particular on the circumference about the length D2 and the width D3, and here lies between the cushion upper side 54 and the cushion lower side 55. The thickness D1 of the air cushion is thus adjustable by filling the second air chamber 52 with air in a variable manner. The air cushion 51 herein is stabilized by the cushion collar 56. The maximum thickness D1 of the air cushion 51 is between 4 cm and 20 cm, preferably between 8 cm and 18 cm, furthermore preferably between 11 cm and 17 cm, and particular preferably between 12 cm and 16 cm. Moreover, the maximum thickness D1 of the air cushion 51 is smaller than the length D2 and the width D3 of the air cushion 51. The width D3 of the air cushion 51 in turn is smaller than the length D2 of the air cushion 51.

In absolute values, the maximum length D2 of the air cushion 51 is between 20 cm and 55 cm, preferably between 25 cm and 50 cm, furthermore preferably between 30 cm and 46 cm, and particularly preferably between 35 cm and 43 cm. Moreover, the maximum width D3 of the air cushion 51 is between 8 cm and 25 cm, preferably between 10 cm and 24 cm, furthermore preferably between 12 cm and 23 cm, and particularly preferably between 13 cm and 22 cm.

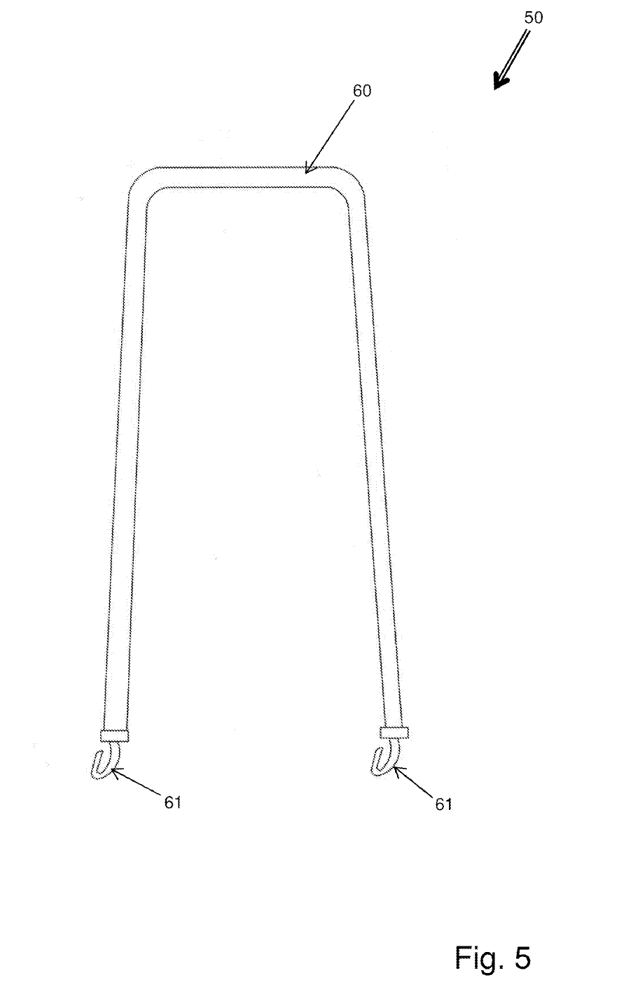

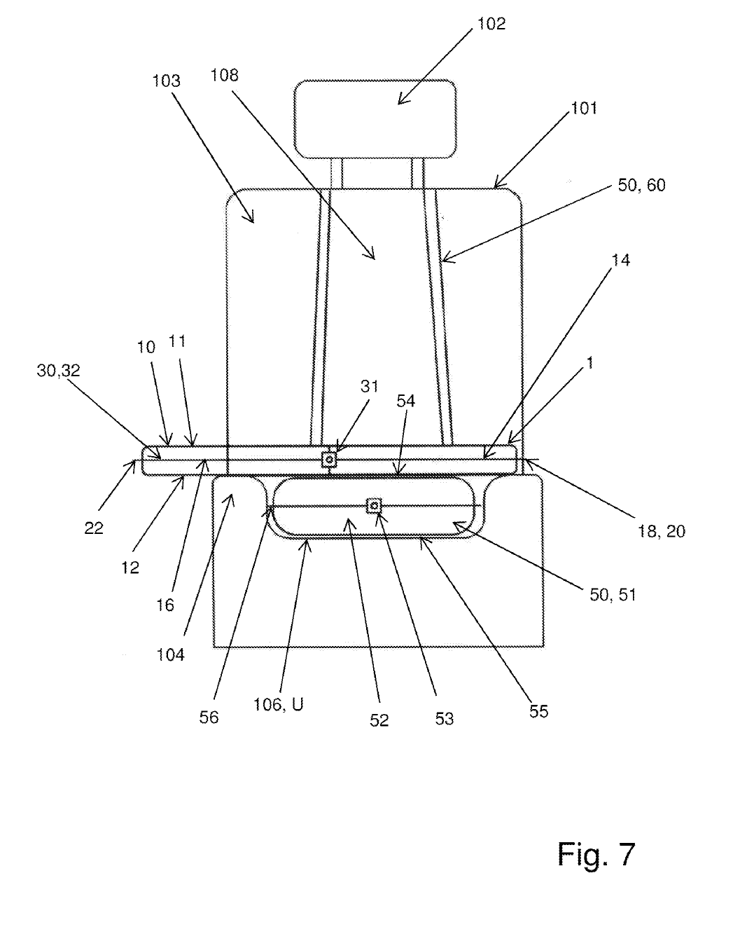

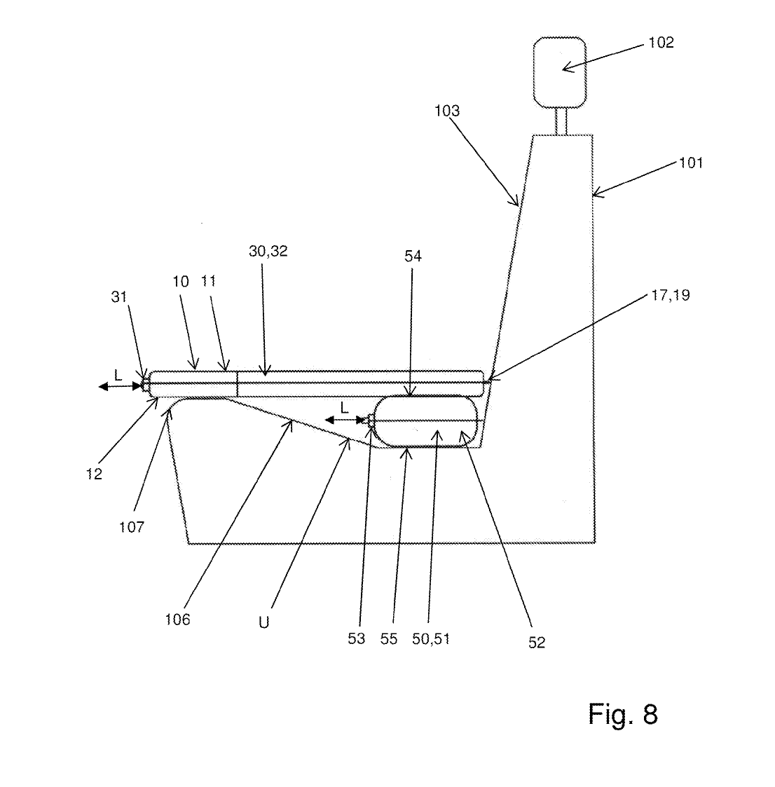

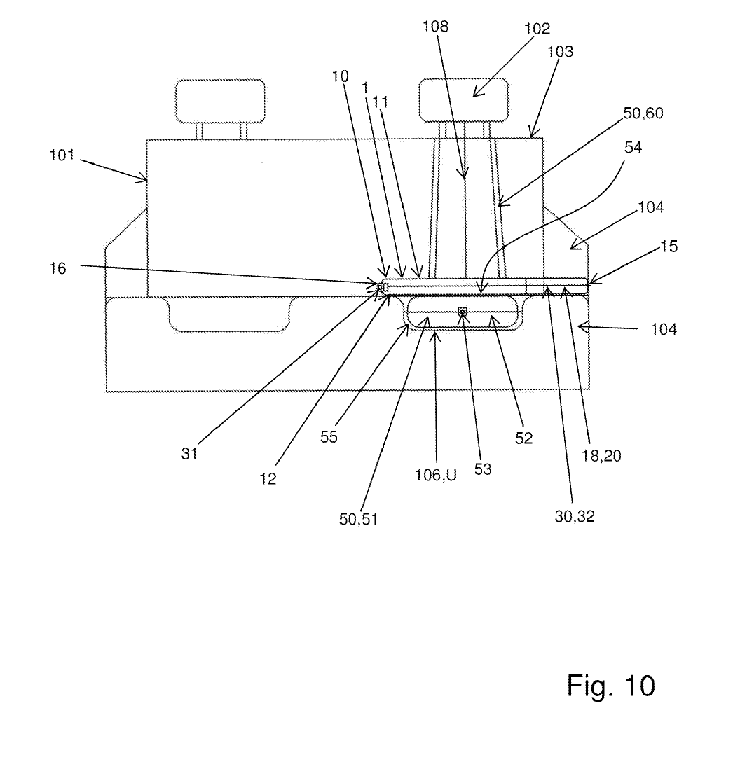

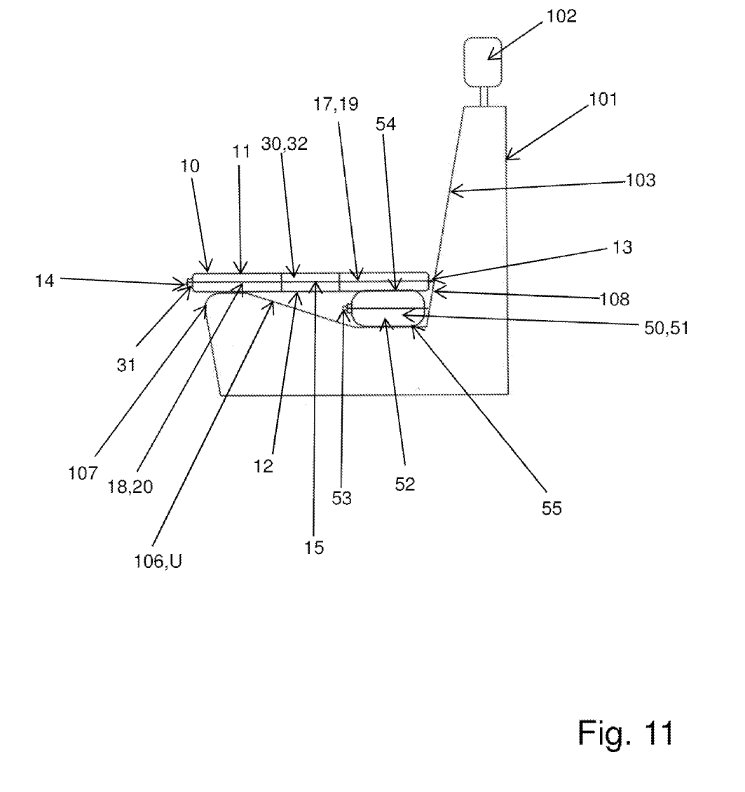

When the dimensional specifications of the air cushion 51 are compared with those of the baby-changing mat 10 as per FIGS. 1, 2, and 3, it can be seen in particular in FIGS. 5 to 11 that the maximum thickness D1 of the air cushion 51 is larger than the spacing A2 between the upper side 11 and the lower side 12 of the baby-changing mat 10. Moreover, the length D2 and the width D3 of the air cushion 51 are smaller than the spacing A1 between the first and the second lateral delimitation 13, 14 of the baby-changing mat 10.

The air cushion 51 and the baby-changing mat 10 thus have in each case a separate air chamber 30, 52 and separate air valves 31, 53. The first air chambers 30 and the second air chamber 52 do not have any gas-permeable connection. Moreover, the first air valve 31 and the second air valve 53 are dissimilar.

FIG. 5 shows a perspective view of a straightening device 50 that is configured as a holding strap 60. Said holding strap 60 can be used on its own or in combination with the straightening device 50 as per FIG. 4 that is embodied as the air cushion 51, in order for a baby-changing mat 10 according to FIGS. 1 to 3 over a geodetically oblique support surface to be aligned so as to be geodetically straight. In particular, such a holding strap can be fixed to a headrest 102 of a vehicle in order for the baby-changing mat 10 to be mounted in a suspended manner at least on one side. To this end, the holding strap 60 is fixable to the baby-changing mat 10, in particular with the aid of hook-shaped hooking means 61 at the two free ends of the holding strap 60. Said hooking means 61 can be fixed in the hanger holes 21 in the baby-changing mat 10 by being hooked thereinto.

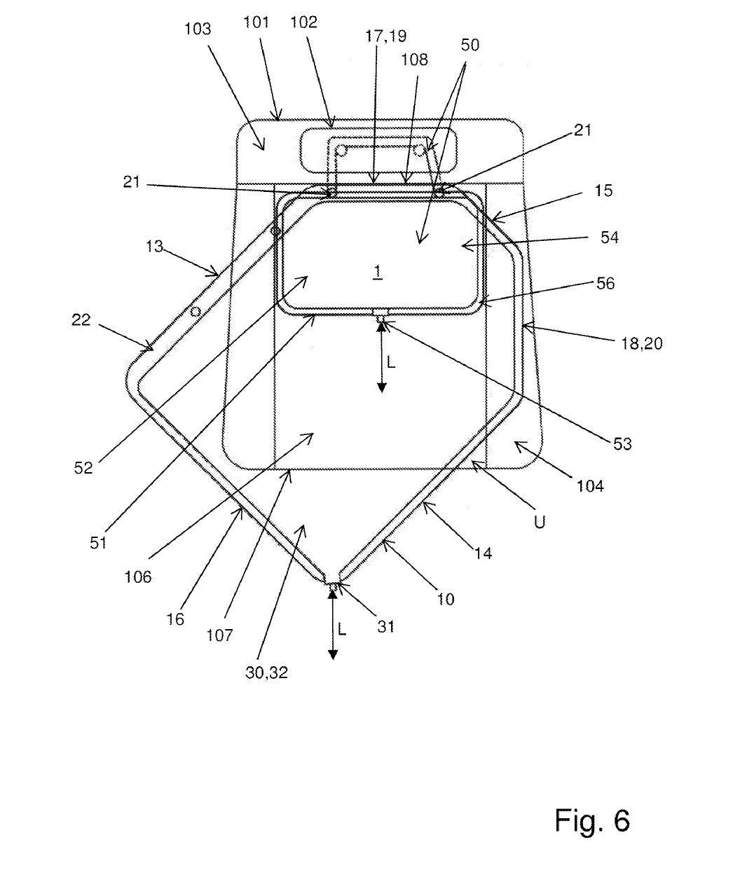

It can be seen in FIGS. 6 to 11 how a geodetically straight lying surface is achieved on a non-planar support surface U in the form of a vehicle seat 101 by way of a baby-changing device 1 having a baby-changing mat 10 as per FIGS. 1, 2, and 3 and a straightening device 50 comprising an air cushion 51 as per FIG. 4 and a holding strap 60 as per FIG. 5.

In terms of the baby-changing mat 10 shown in FIGS. 6 to 11 reference is made to the above description in the context of FIGS. 1 to 3. Moreover, in terms of the air cushion 10 reference is made to the above description in the context of FIG. 4, and relating to the holding strap 60 reference is made to the above description in the context of FIG. 5.

Beyond the description of the individual parts, the mutual relative arrangement of the baby-changing mat 10, the air cushion 51, and the holding strap 60 can be seen in FIGS. 6 to 11. The air cushion 10 lies in each case in a seat depression of a seat face 106 and between two side bolsters 104 and below the lower side 12 of the baby-changing mat 10. Moreover, the holding strap 60 is hooked to a headrest 102 in all embodiments of FIGS. 6 to 11.

Types of uses that deviate in particular by way of a deviating orientation of the baby-changing mat 10 on the vehicle seat 101 are shown in FIGS. 6 to 8 and FIGS. 9 to 11, said types of uses however being in each case suitable for changing the diaper of the baby or an infant on the vehicle seat 101.

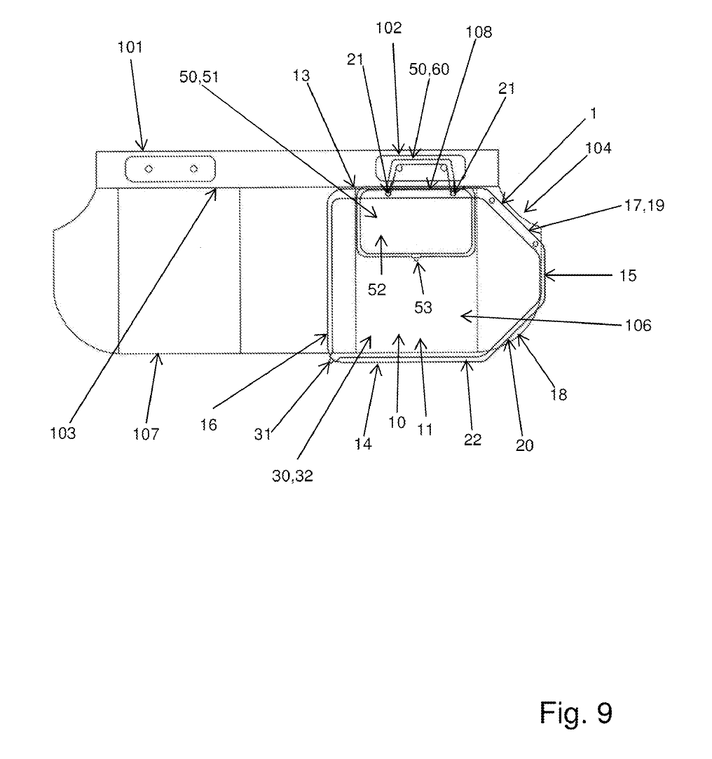

It can thus be seen in FIGS. 9 to 11 that a side bolster 104 of a backrest 103 of the vehicle seat 101 lies in the first blunt corner 17 of the baby-changing mat 10, and the first and the second lateral delimitation 13, 14 are aligned so as to be parallel with a front seat edge 107 of a seat face 106 of the vehicle seat 101.

By contrast, in the use as per FIGS. 6 to 8 a central part 108 of the backrest 103 lies in the first blunt corner 17. In particular, the first corner edge 19 abuts said central part 108. On account thereof, the first and the second lateral delimitation 13, 14 are aligned diagonally in relation to a front seat edge 107 of the seat face 106 of the vehicle seat 10.

In both types of uses as per FIGS. 6 to 8 and FIGS. 9 to 11, the baby-changing mat 10 can be rigidified by filling the first air chamber 30 with air L and over the geodetically oblique support surface U be aligned so as to be geodetically straight by way of the straightening device 50. In use, the geodetic alignment of the baby-changing mat 10 over the geodetically oblique support surface U can be achieved by setting the quantity of air in the air cushion 51 below the baby-changing mat 10 and/or fixing the holding strap 60 above the baby-changing mat 10 and setting the length of the holding strap 60. The baby-changing mat 10 in part is additionally supported on side bolsters 104 of the seat face 106. The baby or the infant for changing the diaper can subsequently be placed onto the upper side 11.

The invention is not limited to any of the previously described embodiments but can be modified in many ways.

All features and advantages, including constructive details, spatial arrangements, and method steps, that are derived from the claims, the description, and the drawing, can be relevant to the invention both individually as well as in the most varied combinations.

LIST OF REFERENCE SIGNS

| | |
|---|---|
| 1 | Baby-changing device |
| 10 | Baby-changing mat |
| 11 | Upper side |
| 12 | Lower side |
| 13 | First lateral delimitation |
| 14 | Second lateral delimitation |
| 15 | Front end |
| 16 | Rear end |
| 17 | First blunt corner |
| 18 | Second blunt corner |
| 19 | First corner edge |
| 20 | Second corner edge |
| 21 | Hanger hole |
| 22 | Collar |
| 30 | First air chamber |
| 31 | First air valve |
| 32 | Unfolding means |
| 50 | Straightening device |
| 51 | Air cushion |
| 52 | Second air chamber |
| 53 | Second air valve |
| 54 | Cushion upper side |
| 55 | Cushion lower side |
| 56 | Cushion collar |
| 60 | Holding strap |
| 61 | Hooking means |
| 101 | Vehicle seat |
| 102 | Headrest |
| 103 | Backrest |
| 104 | Side bolster |
| 106 | Seat face |
| 107 | Front seat edge |
| 108 | Central part (backrest) |
| A1 | Spacing (between the lateral delimitations) |
| A2 | Spacing (between upper side and lower side) |
| A3 | Spacing (between the front end and the rear end) |
| D1 | Thickness (air cushion) |
| D2 | Length (air cushion) |
| D3 | Width (air cushion) |
| L | Air |
| U | Support surface |

1. A baby-changing mat (10) comprising:
an upper side (11);
a lower side (12);
a first lateral delimitation (13) and a second lateral delimitation (14), said lateral delimitations (13, 14) being mutually opposite; and
a front end (15) and a rear end (16), said ends (15, 16) being aligned so as to be transverse to the first and the second lateral delimitation (13, 14); wherein
the front end (15) in comparison to the rear end (16) has a taper.

2. The baby-changing mat (10) as claimed in claim 1, wherein the first lateral delimitation (13) and the second lateral delimitation (14) are aligned so as to be at least substantially mutually parallel.

3. The baby-changing mat (10) as claimed in claim 1, wherein the taper is at least in part configured by a first blunt corner (17) between the front end (15) and the first lateral delimitation (13)

4. The baby-changing mat (10) as claimed in claim 3, wherein the first blunt corner (17) is configured by an oblique first corner edge (19) of the baby-changing mat (10).

5. The baby-changing mat (10) as claimed in claim 3, wherein the taper is at least in part configured by a second blunt corner (18) between the front end (15) and the second lateral delimitation (14).

6. The baby-changing mat (10) as claimed in claim 1, wherein at least one first air chamber (30) is disposed in said baby-changing mat (10), wherein the baby-changing mat (10) is rigidified upon charging the first air chamber (30) with air (L).

7. The baby-changing mat (10) as claimed in claim 6, wherein said baby-changing mat (10) has elastic unfolding means (32) which exert an unfolding force on the first air chamber (30).

8. A baby-changing device (1) having a baby-changing mat (10) as claimed in claim 1, and a straightening device (50) by way of which the baby-changing mat (10) over a geodetically oblique support surface (U) is alignable so as to be geodetically straight.

9. The baby-changing device (1) as claimed in claim 8, wherein the straightening device (50) has an air cushion (51) which is disposed on or below the lower side (12) of the baby-changing mat (10).

10. The baby-changing device (1) as claimed in claim 8, wherein the straightening device (50) has a holding strap (60) which is fixable to a headrest (102) of a vehicle.

11. A method of using the baby-changing device (1) as claimed in claim 8, for changing the diapers of a baby or infant.

12. The method of using the baby-changing device (1) as claimed in claim 11 on a vehicle seat (101) of a vehicle.

13. The method of using the baby-changing device (1) as claimed in claim 12, wherein a side bolster (104) of a backrest (103) of the vehicle seat (101) lies in the taper, and the first and the second lateral delimitation (13, 14) are aligned longitudinally in relation to a front seat edge (107) of a seat face (106) of the vehicle seat (101).

14. The method of using the baby-changing device (1) as claimed in claim 12, wherein a central part (108) of a backrest (103) of the vehicle seat (101) lies in the taper, and the first and the second lateral delimitation (13, 14) are aligned diagonally in relation to a front seat edge (107) of a seat face (106) of the vehicle seat (101).

15. The method of using the baby-changing device (1) as claimed in claim 11, wherein at least one first air chamber (30) is disposed in the baby-changing mat (10), wherein the baby-changing mat (10) is rigidified by charging the first air chamber (30) with air (L).

16. The method of using the baby-changing device (1) as claimed in claim 11, wherein the baby-changing device (1) has a straightening device (50) by way of which the baby-changing mat (10) over a geodetically oblique support surface (U) is aligned so as to be geodetically straight.

17. The method of using the baby-changing device (1) as claimed in claim 16,
wherein the straightening device (50)
has an air cushion (51) which is or is to be disposed on or below the lower side (12) of the baby-changing mat (10); and/or
has a holding strap (60) which is fixable to a headrest (102) of a vehicle; and
wherein a geodetic alignment over the geodetically oblique support surface (U) is performed by
setting the quantity of air in the air cushion (51) below the baby-changing mat (10); and/or
fixing the holding strap (60) above the baby-changing mat (10) and setting the length of the holding strap (60).
